(19) United States
(12) Patent Application Publication
(10) Pub. No.: US 2010/0271955 A1
(43) Pub. Date: Oct. 28, 2010

(54) COMMUNICATION SYSTEM

(75) Inventor: Toshiyuki ATSUMI, Kamakura (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/767,148

(22) Filed: Apr. 26, 2010

(30) Foreign Application Priority Data
Apr. 27, 2009 (JP) 2009-107286

(51) Int. Cl. H04L 12/56; H04L 12/26

(52) U.S. Cl. 370/241; 370/389

(57) ABSTRACT

A communication system with improved fairness of band allotment among the users accommodated by different node. Traffic received by UNI interface and traffic received by NNI interface are stored in separate queues and the respective numbers of paths received by the UNI interface and the NNI interface are measured based on route information. The traffic received by the UNI interface and the traffic received by the NNI interface are distributed based on the measured result.

### INCORPORATION BY REFERENCE

The present application claims priority from Japanese application JP2009-107286 filed on Apr. 27, 2009, the content of which is hereby incorporated by reference into this application.

### BACKGROUND OF THE INVENTION

The present invention relates to priority control of a communication system.

In recent years, the broadband lines including the internet are widespread to home and the line demand is increased centering on the IP traffic, so that the services included therein are also being diversified rapidly.

Under such circumstances, in order to guarantee the communication quality required to forward the IP traffic including various services, the importance of the “QoS (Quality of Service)” which is an approach to the guarantee for request for securing resources of the network and maintenance of the secured resources is increasingly raised.

The QoS control is to guarantee the communication quality required to provide the services included and concrete parameters of the communication quality mainly contain factors defined by “rate”, “delay time”, “jitter (fluctuation)”, “loss” and the like of packets.

The control performed in units of flow of packet, of the QoS control is named Intserv and the control performed in units of class of packet is named Diffserve, which are both stipulated by IETF (Internet Engineering Task Force) (for example, refer to RFC2475 An Architecture for Differentiated Services).

In the Intserv, communication is performed on transmission and reception sides of the flow to secure the bandwidth and the resources required for forwarding in advance in order to guarantee the communication quality matched to the characteristic of traffic and as a representative of the signaling protocol for securing the resources dynamically, there is RSVP (Resource Reservation Protocol).

However, since this model requires to secure or maintain the resources in units of flow, the load on router apparatuses is extremely increased due to the increased number of flows and the scalability is difficult.

On the other hand, the Diffserv is a system proposed to this defect and puts emphasis on performance and scalability.

Concretely, a value of DSCP (Diffserv Code Point) for identifying service class is given at edge of Diffserv domain and priority control among service classes is performed on the basis of the DSCP value in nodes after that.

The priority control using the Diffserv model performs processing for each of service classes instead of individual detailed flows in units of processing and for each of nodes and accordingly is excellent in the scalability. This priority control is the mainstream in the large-scale network.

### SUMMARY OF THE INVENTION

FIG. 1 schematically illustrates general configuration of the priority control.

The priority control includes queues 100 for storing therein packets, a distributor 101 for identifying received flows to distribute them to the queues for each of the services and a scheduler 102 for reading out data stored in the queues on the basis of a certain priority control algorithm.

The received packets are distributed to predetermined queues for each of the services and have the priority of data forwarding decided in order in which the scheduler reads out data from the queues.

Typical scheduler systems include the PQ (Priority Queuing) for reading out data stored in the queues sequentially in order of data stored in a queue having a high priority, the WRR (Weighted Round Robin) for reading out a number of packets based on certain weight according to the priority and the WFQ (Weighted Fair Queuing) for reading out a number of bytes based on certain weight according to the priority. There exist various scheduler systems having different purposes and service forms thereof.

As a representative packet switching system which provides such a priority control, there is known a MPLS (Multi Protocol Label Switch). In the MPLS, the packet received is given an identifier of 20 bits called as “label” at an edge node corresponding to an input end of a MPLS network. In the MPLS network, the “label” given to the packet is used to search for next hop to forward data thereto, so that the data is forwarded to the hop. Each MPLS apparatus has a “label table” in which labels and next hops correspond to each other and collates the “label” of MPLS header with the “label table”, so that the next hop to forward data thereto is decided.

The correspondence between labels and routes is made in accordance with the signaling protocol such as LDP (Label Distribution Protocol) and RSVP (Resource Reservation Protocol) and the “label table” is prepared in units of node on the basis of the label distributed to each node. In this manner, the MPLS is characterized by the fact that route information can be exchanged among nodes so that the node can decide a route autonomously to prepare and hold the label table and the forwarding route using the label can be treated as a logical path. Such various protocols are techniques which have been already standardized in IETF and are widespread in the market.

Moreover, in recent years, the route management method in which the MPLS that is the autonomous dispersion type protocol in which nodes exchange the route information with one another like LDP to autonomously decide the route is expanded so that the network management apparatus manages nodes unitarily and the maintenance person decides the route explicitly is being standardized in IETF as MPLS-TP (Multi Protocol Label Switch Transport Profile) in which the concentrated management type network is new technique of the packet transport network.

In the priority control of Diffserv, packets are not distributed to queues in units of service or user but are distributed thereto according to the service classes. Accordingly, in the Diffserv, a plurality of services and user data belonging to the same service class are stored in the same queue.

For example, it is supposed that there are EF (Expedited Forwarding), AF (Assured Forwarding) and BE (Best Effort Forwarding) (priority order is EF>AF>BE). In this case, as shown in FIG. 2, queues are separately provided in EF, AF and BE and data for plural users are stored in each queue.

If the scheduler reads out data from the queues in priority order of EF>AF>BE, data are preferentially forwarded in order of EF>AF>BE, so that differentiation in relative priority among service classes can be realized.

However, in Diffserv, the above processing operation is performed for each node in units of service class instead of units of user or service and accordingly the amount of traffic per user is not uniform due to difference of the number of nodes through which data pass in traffic except the band guarantee type, for example, BE traffic.

Description is made now by taking BE traffic as an example.

As shown in FIG. 3, it is supposed that in the network including 3 nodes A, B and C, 500 Mbit/s is secured in BE band between nodes and 3 user lines using 100 Mbit/s band as BE traffic are multiplexed in the node A, 4 user lines using 100 Mbit/s band as BE traffic being multiplexed in the node B, 2 user lines using 100 Mbit/s band as BE traffic being multiplexed in the node C. At this time, 300 Mbit/s for input side band and 500 Mbit/s for output side band in total are ensured in the queue accommodating BE traffic of the node A and accordingly traffic of 300 Mbit/s is transmitted to the node B as it is.

Next, when the node B is considered, 300+400=700 Mbit/s for input side band and only 500 Mbit/s for output side band in total are ensured in the queue accommodating BE traffic and accordingly the band of each user signal is limited to 5/7 at the output of multiplexed signal in the node B and the band of each user is 100× 5/7=71.4 Mbit/s.

Next, when the node C is considered, 500+200=700 Mbit/s for input side band and only 500 Mbit/s for output side band in total are ensured in the queue accommodating BE traffic and accordingly the band of each user signal is limited to 5/7 at the output of multiplexed signal in the node C and the band of user in the nodes A and B is 71.4× 5/7=51.0 Mbit/s, the band of user in the node C being 100× 5/7=71.4 Mbit/s. That is, the band usable by the each user at the output of multiplexed signal in the node C is different in dependence on node and the more downstream the signal reaches, the more advantageous the allotment of band is even among the users belonging to the same service class.

In order to keep the fairness among the users, queue can be provided for each of users and data can be read out from each queue to be forwarded so that the fairness can be kept on the basis of any policy. However, since the larger the network is, the more the users are accommodated, it is difficult to provide the queue for each of users and the scalability is limited by the number of queues.

When the empty band beyond the guaranteed band is utilized to accommodate user signals efficiently by statistical multiplex effect like the BE (Best Effort) traffic and the Diffserv system in which the band control is performed for each of service classes is adopted, the band control is not performed in units of user and accordingly the rate of use bands allotted actually is unfair among users in dependence on the position of node which accommodate user signals even in users provided with line service of Best Effort that is the same service class.

The present invention provides means for identifying UNI interfaces in which users are accommodated and NNI interfaces which connects among band control apparatuses by way of example and comprises means for storing traffic received by the UNI interface and traffic received by the NNI interface into separate queues and measuring the numbers of paths received by the UNI and NNI interfaces on the basis of static route information set by a network management apparatus when priority control of traffic is performed and means for scheduling the traffic received by the UNI interface and the traffic received by the NNI interface on the basis of the measured result.

The fairness for allotment of the band among users belonging to the service class of Best Effort can be more improved to thereby secure the fairness for allotment of the band among users accommodated by different node. The feeling of unfairness for allotment of use band for each user caused by different accommodation positions can be solved to the users provided with the line service of Best Effort and new worth of the fairness of allotment of the band among users accommodated by different node in Best Effort line service is provided to the communication entrepreneur providing the line service.

Other objects, features and advantages of the invention will become apparent from the following description of the embodiments of the invention taken in conjunction with the accompanying drawings.

### BRIEF DESCRIPTION OF THE DRAWINGS

FIG. 1 schematically illustrates an example of priority control performed in a band control apparatus;

FIG. 2 schematically illustrates an example of forwarding configuration when data is forwarded on the basis of priorities of different service classes;

FIG. 3 schematically illustrates an example of a band control apparatus for multiplexing user lines;

FIG. 4 schematically illustrates an example of configuration of band control apparatuses according to the present invention;

FIG. 5 schematically illustrates an example of configuration of a band control apparatus according to the present invention;

FIG. 6 shows a format of MAC frame in which VLAN tag is inserted;

FIG. 7 shows a format of MPLS frame;

FIG. 8 shows an example of an information table to be held by the apparatus when data is forwarded as E-LSP;

FIG. 9 shows an example of MPLS cross-connect table;

FIG. 10 schematically illustrates an example of configuration of a priority control part and its peripheral block of a band control apparatus according to a first embodiment of the present invention;

FIG. 11 schematically illustrates an example of configuration of a priority control part and its peripheral block of a band control apparatus according to a first embodiment of the present invention; and

FIG. 12 illustrates an example of a method of calculating the number of THR paths in THR path measurement part.

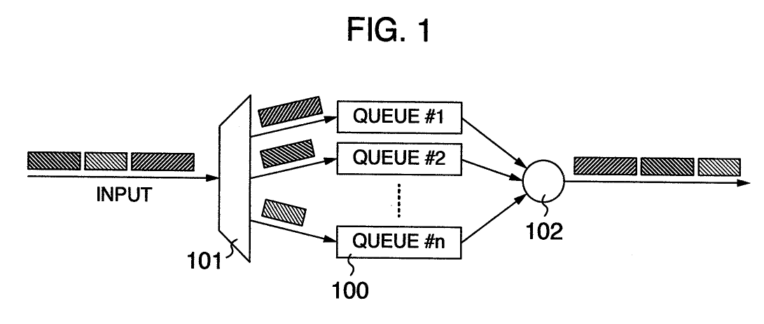

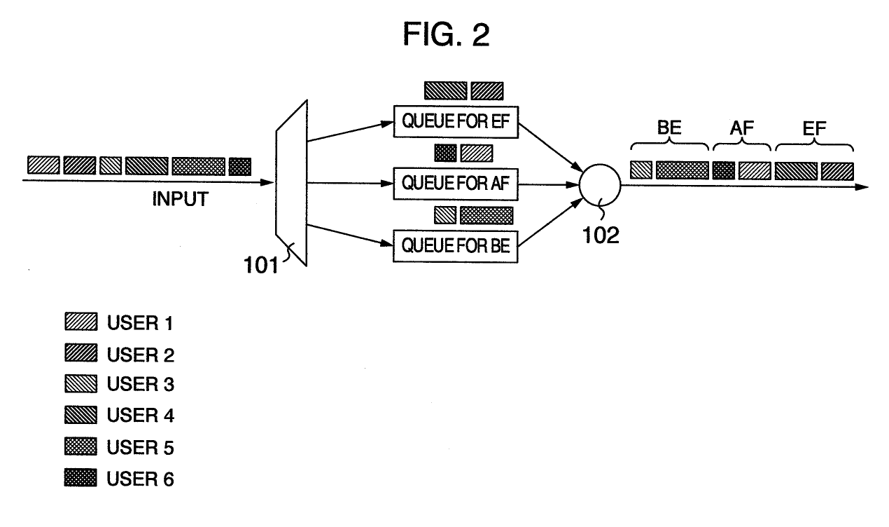

### DETAILED DESCRIPTION OF THE EMBODIMENTS

Some embodiments of the present invention are now described with reference to the accompanying drawings.

### Embodiment 1

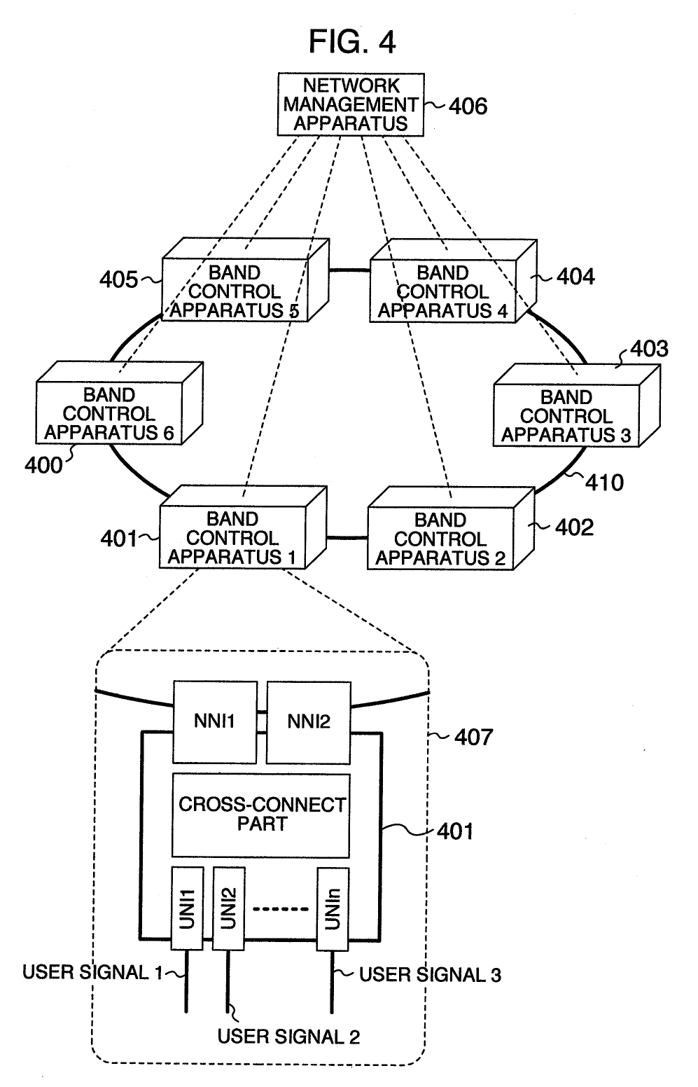

FIG. 4 schematically illustrates basic configuration of a network structured by band control apparatuses of the present invention and the band control apparatus. In the embodiment, a network form in which band control apparatuses 400 to 405 are connected through a network 410 in the form of ring as shown in FIG. 4 and user signals are accommodated in a certain node and are forwarded to another node is described by way of example.

As shown in an enlarged drawing 407 of FIG. 4, the band control apparatus (401 as an example) includes 2 NNIs (Network Node Interfaces) (NNI1 and NNI2) for connecting nodes, n UNIs (User Network Interfaces) (UNI1 to UNIn) for accommodating user signals and a cross-connect part having the cross-connect function for forwarding signal received in the interface (NNI1, NNI2, UNI1 to UNIn) to any interface (NNI1, NNI2, UNI1 to UNIn). It is premised that the cross-connect part is not the circuit switching of a continuous data stream like SDH and SONET but the packet switching for performing cross-connect in units of packet like IP and Ethernet (registered trademark). UNI is an interface of data communication between the band control apparatuses and user terminals communicating therewith.

The band control apparatuses are connected to one another through the NNI interfaces and constitute ring topology. In the embodiment, the ring network is described by way of example for simplification, although the present invention can be applied to any network topology such as mesh network by increasing the number of NNI interfaces regardless of topology of network.

Moreover, a network management apparatus 406 for monitoring the band control apparatuses to control them is connected to the network consisting of the band control apparatuses. The route information of user signals in the network indicating that the user signal is accommodated by which UNI interface, it passes through which node and it is separated by which UNI interface is set through the network management apparatus on the basis of the maintenance person's instruction. The network management apparatus sets the route information to the band control apparatuses and manages the route information as database. Furthermore, it is not necessarily required that the band control apparatuses and the network management apparatus for managing the monitoring and control function of the band control apparatuses are connected directly in a one-to-one correspondence manner physically and both of them may be connected in any connection configuration as far as both are connected logically through the general public network such as DCN and monitor and control each other therebetween.

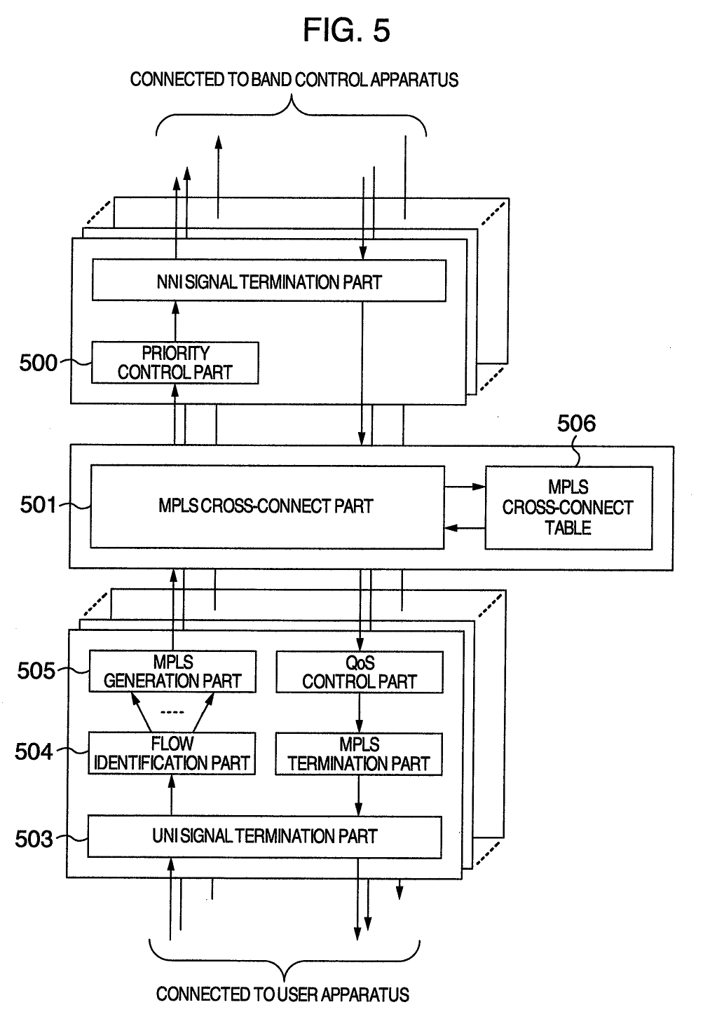

FIG. 5 schematically illustrates the band control apparatus. In the embodiment, Ethernet (registered trademark) signal with VLAN tag is accommodated as the user signal. The band control apparatus including a flow identifying part (504) which identifies the service class in accordance with the priority of VLAN tag and performs packet switching and data forwarding while controlling the band in accordance with the service class is described by way of example. The configuration of the band control apparatus including an MPLS (Multi Protocol Label Switch) switch (MPLS cross-connect part 501) to which the packet switch system named MPLS is applied is described concretely by way of example.

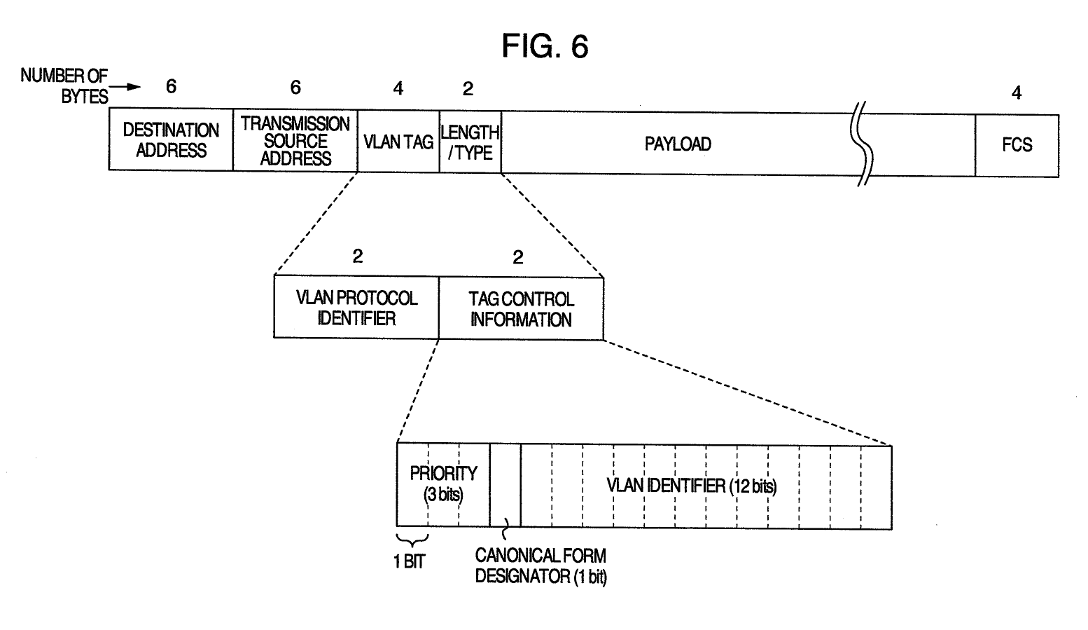

FIG. 6 shows a format of MAC frame in which VLAN tag is inserted. The VLAN tag in Ethernet (registered trademark) includes 4 bytes in total of VLAN protocol identifier (2 bytes) and tag control information (2 bytes) inserted between transmission source address of MAC frame and length/type field. Further, the tag control information includes 12-bit VLAN identifier, 1-bit canonical form designator and 3-bit priority field. The priority field stores therein a value indicating the priority of data forwarding of the flow. The priority is defined to be 7 for the highest priority and 0 for lowest priority in LAN switch and the data forwarding processing is performed on the basis of the priority.

As described above, in the priority control in Diffserv, packets are not distributed to queues in units of service or user but are distributed according to the service class. Since the number of service classes is different in dependence on the kind of communication service provided by communication carrier, the number of service classes provided by the communication carrier is not necessarily equal to the number of priorities and is sometimes different even depending on ports. The standard method of making correspondence between the number of service classes and the priority of user represented by VLAN is stipulated in IEEE802.1p. When the priority control is performed on the basis of the priority of 3 bits instead of each user indicated by the VLAN identifier, a plurality of different services and user data belonging to the same service class are stored in the same queue. In the embodiment, the plurality of different services (users) belonging to the same service class as described above are integrated to perform the priority control (using Diffserv).

The Ethernet (registered trademark) signal having the VLAN tag in which the priority of data is defined as described above is transmitted from the user device and received by UNI signal termination part 503 of the band control apparatus of the embodiment. In the UNI signal termination part, the signal is usually subjected to the termination processing of signal conforming to the kind or format of the user signal and transmitted to a flow identification part 504. When the user signal is Gigabit Ethernet (registered trademark), the signal is converted into electrical signal when the signal is light signal and MAC frame is then extracted from a stream of data received, so that header fields and FCS (Frame Check Sequence) are examined to confirm the normality of data and the frame having normal examination result is transmitted to the flow identification part.

The flow identification part performs making correspondence to the service classes on the basis of the priority of VLAN tag. For example, when 3 service classes including EF (Expedited Forwarding), AF (Assured Forwarding) and BE (Best Effort) are provided, priorities 7 and 6 are assigned to EF class and priorities 5, 4, 3 and 2 to AF class, priorities 1 and 0 to BE class. In IEEE802.1p, the standard allotment method is provided, although the allotment of the priorities to the service classes is not necessarily required to conform to the above allotment and allotment may be changed in accordance with service provided.

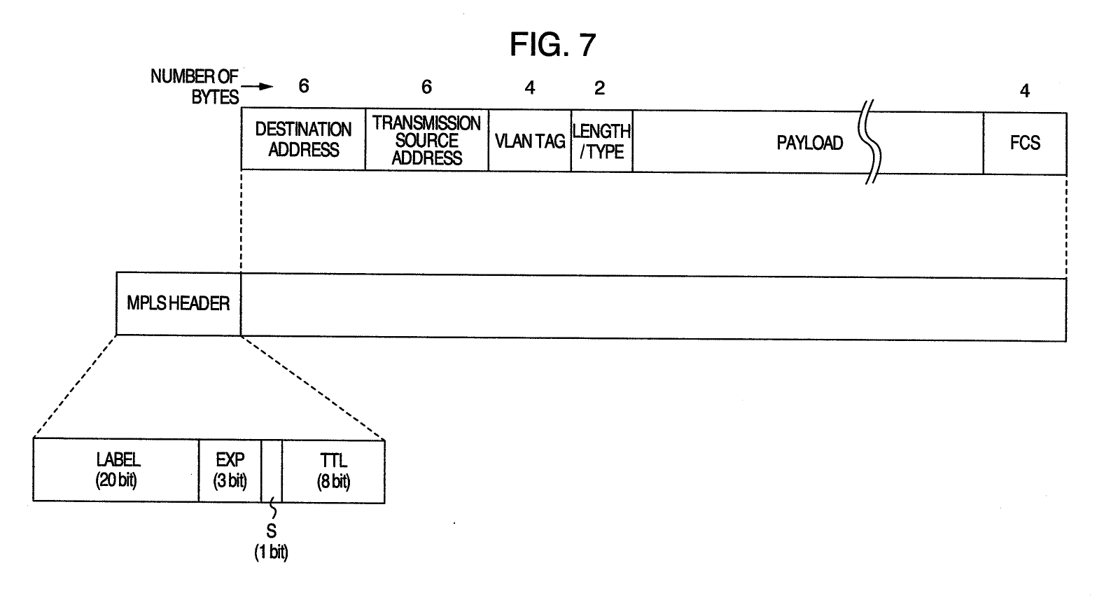

The flow identified by the flow identification part for each service class is transmitted to an MPLS generation part 505. The MPLS generation part gives a header of MPLS to the MAC frame received by UNI signal termination part to generate MPLS frame. FIG. 7 shows the MPLS frame generated by giving the MPLS header to the MAC frame. In FIG. 7, the contents from destination address to FCS field of the MAC frame received by the UNI signal termination part are extracted and the MPLS header of 4 bytes is given before the destination address. The MPLS header includes 32 bits in total containing label field of 20 bits, EXP (Experimental use) field of 3 bits, S field of 1 bit and TTL (Time To Live) field of 8 bits. The label field stores therein label identifier of MPLS and packets are forwarded on the basis of the label value. The EXP field may be used as the field indicating the priority at the time that priority processing of MPLS frame is performed as described later. The S bit is defined to represent whether the MPLS header is at the final stage when plural MPLS headers are given in a stacked manner and the header having “S=1” is at the final stage. The TTL field represents the existence time of packet and is given at the edge of MPLS network. The existence time is subtracted by one for each hop and the packet having TTL=0 is discarded. The TTL field is to be defined in order to avoid the problem that if a loop is formed in a packet forwarding route in the MPLS network and the packet continuously remains in the network without reaching the end point of the forwarding route. In the embodiment, the number of stages of the MPLS header is 1 (only S=1) and MPLS header is not stacked, although even when the MPLS headers are stacked, the same effects can be attained by the same method as described in the embodiment.

In order to perform the priority control on the basis of VLAN priority in MPLS network, when 4-byte MPLS header is given in the MPLS generation part, it is necessary to take over information stored in the priority field of VLAN tag to MPLS header. As the method of taking over the priority to MPLS header, there are 2 kinds of methods named L-LSP (Label-Only-Inferred-PSC-Label Switched Path) in which the service classes are made to correspond to label values of 20 bits and LSP (Label Switched Path) is constructed and E-LSP (EXP-Inferred-PSC-Label Switched Path) in which service classes are made to correspond to EXP values of 3 bits and LSP is constructed and both of them are stipulated in IETF.

When MPLS header is given to MAC frame in the MPLS generation part of FIG. 5, a method of making information of VLAN priority field that is priority information of user signal correspond to value of label field of MPLS or a method of making information of VLAN priority field correspond to value of EXP field is adopted and the correspondence table is held to refer to the correspondence table at the time of data forwarding, so that the service class of MAC frame can be identified even in MPLS network and forwarding processing can be performed on the basis of the service class.

More concretely, in case of L-LSP, correspondence of service classes, VLAN priorities, label values and PHB (Per Hop Behavior) is held in table for each node in network and generation of MPLS frame, taking over of priority and priority control are performed on the basis of the table information so that data forwarding is performed. In case of E-LSP, correspondence of service classes, VLAN priorities, EXP values and PHB is held in table and generation of MPLS frame and priority control are performed on the basis of the table information so that data forwarding is performed.

The PHB means contents of priority control processing to be performed for the flow having a certain priority and the correspondence must be performed in advance.

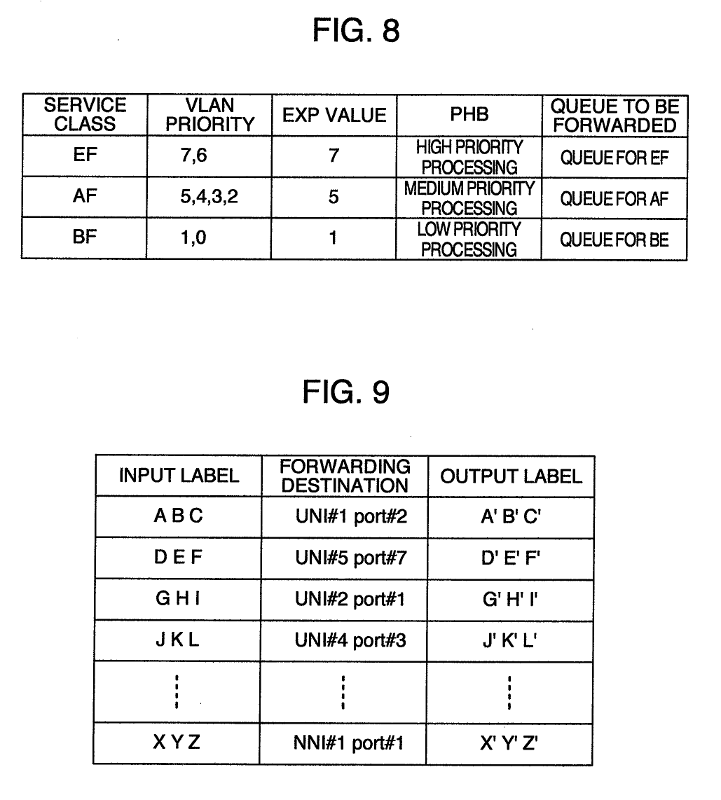

In the embodiment, definite operation is described by taking the case of E-LSP as an example. FIG. 8 shows an example of an information table to be held by the apparatus when data is forwarded as E-LSP. The apparatus previously holds the table in which service classes are made to correspond to VLAN priority of MAC frame, EXP value, PHB and the number of queue to be forwarded as shown in the table of FIG. 8. The MPLS generation part of FIG. 5 decides the EXP value corresponding to the VLAN priority of the MAC frame of this table and gives the label information corresponding to the information of route through which the MPLS frame is to be forwarded and values of TTL and S to the MAC frame as the MPLS header to be forwarded to the MPLS cross-connect part.

When the MPLS generation part generates the MPLS frame, the MPLS generation part makes information concerning the priority of the user signal correspond to the priority of the MPLS frame, although in the embodiment if the priority of the user signal is taken over to the MPLS header, any method of L-LSP or E-LSP or other method may be adopted.

The MPLS cross-connect part refers to label of the MPLS frame forwarded from the MPLS generation part and uses the label value as a key to refer to MPLS cross-connect table 506 held in the apparatus beforehand, so that interface of output destination is decided. FIG. 9 shows an example of the MPLS cross-connect table. The MPLS cross-connect table stores therein input labels of key, output destinations corresponding to the input labels and new label values when the label is rewritten at the time of output in a corresponding manner to one another. When the MPLS cross-connect part receives the MPLS frame from MPLS generation part of UNI or NNI signal termination part of NNI, the MPLS cross-connect part refers to label value of the received MPLS frame and uses the label value as a key to search the input label column of the MPLS cross-connect table for coincident label. When there is a coincident label, the output destination column corresponding thereto is referred to decide the forwarding destination of the MPLS frame. The output label value gotten from the table is write data when the label value is rewritten in interface board of the forwarding destination and accordingly this information is forwarded together with the MPLS frame to the interface board of the output destination. Concretely, when the MPLS frame having the label “XYZ” is received from UNI, the MPLS cross-connect part refers to the MPLS cross-connect table of FIG. 9 to get “NNI#1 port#1” as the output destination corresponding to the input label, so that the MPLS frame is forwarded to “NNI#1 port#1” on the basis of the information and the output label “X′Y′Z′” is also forwarded to “NNI#1 port#1”.

In the embodiment, the network management apparatus automatically decides the label value which is unique in the range where connection is made through the network 410 in response to the maintenance person's instruction of the route performed through the network management apparatus and delivers the route information to the band control apparatuses. The band control apparatuses prepare the MPLS cross connect table on the basis of the delivered information and holds it therein. The label information of nodes is not necessarily required to be decided by the network management apparatus automatically. That is, if the forwarding route of the user signal is decided by the maintenance person's instruction, the label information of nodes may be decided by the maintenance person.

The MPLS frame having the output destination decided by the MPLS cross-connect part is forwarded to the priority control part of the interface board. The MPLS cross-connect part is connected to plural interface boards (UNI interface or NNI interface) and performs switching on the basis of the label value of MPLS and the route information stored in the MPLS cross-connect table, although since the cross-connect system of the MPLS cross-connect part is not realized by the circuit switching but is realized by the packet switching as described above, traffic exceeding the output speed of a specific interface is concentrated as a result of the cross-connect performed and there is a possibility that congestion is caused. In this case, the priority of data forwarding is decided on the basis of a certain policy and data is discarded so that the traffic amount is smaller than or equal to the output speed of the interface board. The data forwarding and the discard processing based on the priority of traffic are the role of the priority control part.

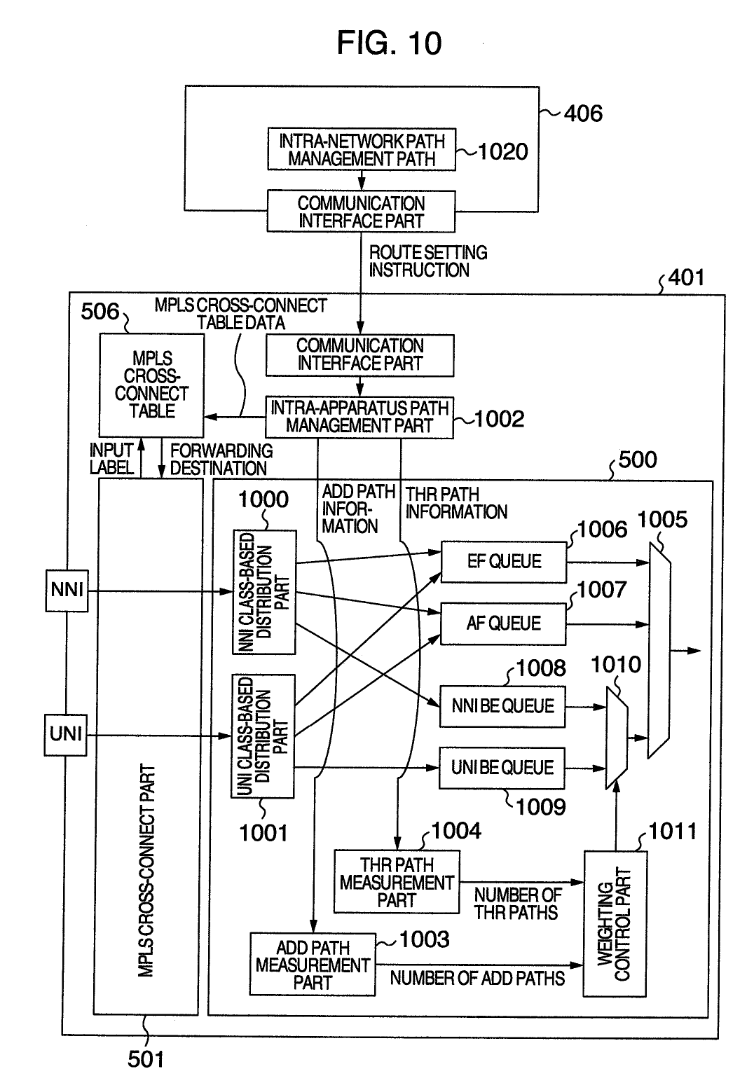

FIG. 10 schematically illustrates an example of configuration containing first block configuration of the priority control part. In FIG. 10, the band control apparatus includes an NNI class-based distribution part 1000 for distributing the MPLS frames received by NNI to the queues according to the service classes, a UNI class-based distribution part 1001 for distributing data received by UNI to the queues according to the service classes, and an intra-apparatus path management part 1002 for managing cross-connect information (path information) indicating where path (flow) passing through the apparatus is inputted from and where the path is outputted to. The band control apparatus is logically connected to the network management apparatus 406 as shown in FIG. 4 and includes a communication interfaced part for exchanging information such as route setting instruction from an intra-network path management part 1020 provided in the network management apparatus to manage the route information from starting points (input points) to end points (output points) in the whole network. The intra-apparatus path management part 1002 generates MPLS cross-connect table data consisting of “input label”, “transfer destination” and “output label” set to the MPLS cross-connect table on the basis of the route setting instruction received from the intra-network path management part 1020 and sets the data to the MPLS cross-connect table. The MPLS cross-connect part 501 transmits the label (input label) of MPLS frame received from UNI or NNI to the MPLS cross-connect table 506. The MPLS cross-connect table is searched using the received input label as a key and the forwarding destination of data relevant to the input label is transmitted to the MPLS cross-connect part 501. The MPLS cross-connect part 501 forwards data on the basis of the received forwarding destination. Moreover, the band control apparatus includes an ADD path measurement part 1003 for measuring the number of paths (flows) forwarded from UNI to NNI of the band control apparatus on the basis of the route information managed by the intra-apparatus path management part, a THR path measurement part 1004 for measuring the number of paths (flows) forwarded from NNI to another NNI of the node on the basis of accommodation information received from accommodation information separation part and route information received from the intra-apparatus path management part, a control part 1005 for scheduling data forwarding on the basis of a certain algorithm and controlling the priority order of packets forwarded in accordance with an amount of traffic data, a control part 1010 at the second stage, and EF queue 1006, AF queue 1007 and BE queues which are buffer memories provided for service classes to queue data read in the control parts. The BE queues include 2 queues of an NNI BE queue 1008 for storing therein MPLS frame received by NNI connected to another band control apparatus and a UNI BE queue 1009 for storing therein MPLS frame received by UNI connected to the user device to accommodate the user signal outputted from the user device. Interface receiving BE traffic distributes the frames to different queues in accordance with NNI and UNI.

The intra-apparatus path management part is connected to the intra-network path management part mounted in the network management apparatus through communication interfaces and the network management apparatus transmits to the intra-apparatus path management part mounted in the band control apparatus the “route setting instruction” indicating that the route leading from which input UNI to which output UNI of the band control apparatus is set as the route information. That is, in FIG. 4, when the maintenance person issues the instruction indicating that a static path leading from the band control apparatus 1 (point A) through the band control apparatuses 2 to 5 to the band control apparatus 6 (point Z) in the network is opened to the network management apparatus, the intra-network path management part of the network management apparatus generates the route information for forming the path from A to Z points for the band control apparatuses at A to Z points and transmits it to the band control apparatuses as the route setting instruction. That is, the route setting instruction from UNI to NNI is transmitted to the node at A point and the route setting instruction from NNI to UNI is transmitted to the node at Z point, the route setting instruction from NNI to another NNI is transmitted to the nodes (band control apparatuses 2 to 5) in relay sections except the above nodes.

The intra-apparatus path management part of the band control apparatus which has received the route setting instruction through the communication interface part from the intra-network path management part of the network management apparatus judges whether the route setting instruction indicates ADD path going from UNI accommodating user signal to NNI connecting the band control apparatuses to one another or THR (Through) path going from NNI to another NNI in order to forward data from a band control apparatus to another band control apparatus on the basis of the route information contained in the route setting instruction. When it is judged that the route setting instruction from the network management apparatus indicates the ADD path, ADD path information is transmitted to the ADD path measurement part and when it is judged that the route setting instruction from the network management apparatus indicates the THR path, the THR path information is transmitted to the THR path measurement part. In order to make the judgment, it is necessary that the intra-apparatus path management part of the band control apparatus judges whether the interfaces are UNI accommodating the user signal or NNI connecting the band control apparatuses to one another. The judgment may be made by slot in which the interfaces are mounted or may be made by information registered beforehand by the maintenance person's instruction or may be made by names of different articles defined as respective interfaces. That is, the judgment may be made by any realizable system as far as NNI and UNI interfaces can be identified. The ADD path measurement part measures the number of paths (flows) forwarded from UNI to NNI on the basis of the route information about its own node received from the intra-apparatus path management part and transmits the measured value to a weighting control part 1011 as the number of ADD paths.

The THR path measurement part measures the number of paths (flows) forwarded from NNI of its own node to another NNI on the basis of the route information received from the intra-apparatus management part and transmits the measured value to the weighting control part as the number of THR paths.

The weighting control part generates weighting information as band condition (transmission condition) information on the basis of the number of ADD paths received from the ADD path measurement part and the number of THR paths received from the THR path measurement part. For example, a ratio of the number of ADD paths to the number of THR paths received from the THR path measurement part is defined as the weighting information and it is transmitted as a weighting processing instruction to the control part 1005.

On the other hand, as the flow of user signal (MPLS frame), data received by NNI of the band control apparatus is forwarded to the NNI class-based distribution part and data received from the UNI interface is forwarded to the UNI class-based distribution part. The NNI class-based distribution part refers to the EXP values corresponding to the service classes given by the MPLS generation part in advance to distribute MPLS frames having EXP=7 to the EF queue, MPLS frames having EXP=5 to AF queue and MPLS frames having EXP=1 to NNI BE queue to be written into queues. The UNI class-based distribution part refers to the EXP values corresponding to the service classes given by the MPLS generation part in advance to distribute MPLS frames having EXP=7 to the EF queue, MPLS frames having EXP=5 to AF queue and MPLS frames having EXP=1 to UNI BE queue to be written into queues. The NNI class-based distribution part and the UNI class-based distribution part are the same in that the frames are distributed to the queues on the basis of the EXP values but are different in that data passing through NNI and data passing through UNI are distributed to different queues for BE traffic (EXP=1).

The control part for reading out data from queues in accordance with specific algorithm is constructed into 2 or more stages and the control part 1005 at the first stage adopts a scheduler such as WFQ in which a ratio (weighting) of reading out of the UNI BE queue and the NNI BE queue can be controlled externally. The control part 1010 at the second stage includes a scheduler which can identify the service classes among EF, AF and BE clearly as PSC (PHB Scheduling Class). In the embodiment, the control part at the second stage includes PQ (Priority Queuing) as an example. First, in the scheduling by WFQ at the first stage, weighting in reading out of data is decided on the basis of weighting information from the weighting control part and reading out and forwarding of data are performed in accordance with the weighting. That is, in this configuration, traffic from NNI stored in NNI BE queue and traffic from UNI stored in UNI BE queue are weighted by the numbers of respective paths (flows) to make reading out and forwarding of data. The ratio of reading out of data is changed in accordance with the ratio of the number of paths (flows) coming in from UNI to the number of paths (flows) coming in from NNI interface to secure the fairness among the users. Furthermore, PQ is used as the control part 1010 at the second stage, so that while traffic having high priority is flowing, absolute priority forwarding that does not forward traffic having lower priority at all can be performed and the priority of forwarding among service classes becomes clear.

In the embodiment, the scheduler is constituted of 2 stages including PQ+WFQ by way of example, although there is no requisite condition except that the control part at the first stage can designate weighting and any scheduler matched to applied service may be adopted. For example, when the control part 1010 at the second stage performs forwarding on the basis of certain weighting among service classes instead of performing absolute priority forwarding, a control part meeting it except PQ may be applied.

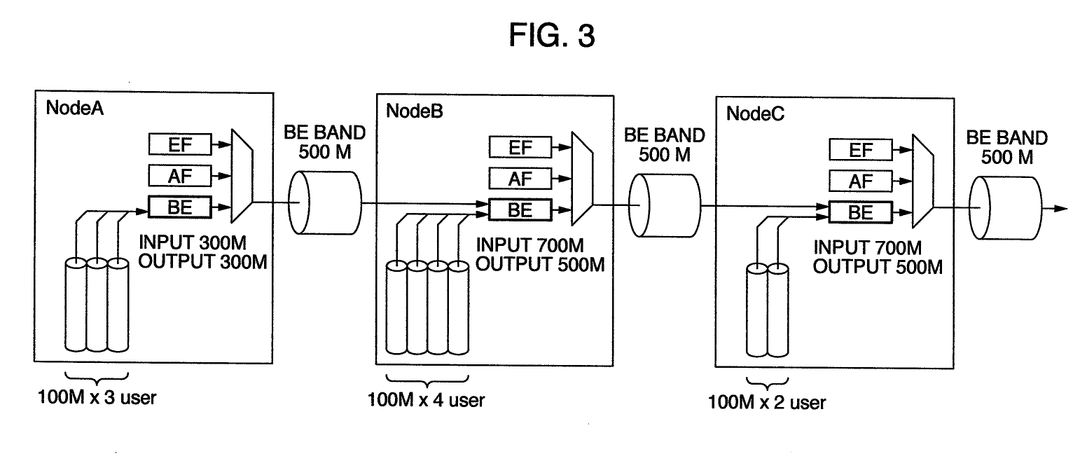

As described above, since the flows are distributed on the basis of contents of the route information instruction set from the network management apparatus, traffic is distributed to 3:4 because of NNI:UNI=3:4 in the node B and traffic is distributed to 7:2 because of NNI:UNI=7:2 in the node C in the case described in FIG. 3. Consequently, the problem in the configuration shown in FIG. 3 is solved as follows:

The band for BE traffic multiplexed in node A is narrowed to 3/7 in accordance with the ratio of the number of paths received in UNI to the number of paths received NNI in this node so that BE traffic in total is 500 Mbit/s in node B and furthermore in node C the band is narrowed to 7/9 in accordance with the ratio of the number of paths received in UNI to the number of paths received in NNI in this node. Accordingly, the traffic at output of node C is 500 Mbit/s× 3/7× 7/9=166.7 Mbit/s/node, that is, 55.6 Mbit/s/user.

The band for BE traffic multiplexed in node B is narrowed to 4/7 in accordance with the ratio of the number of paths received in UNI to the number of paths received NNI in this node so that BE traffic in total is 500 Mbit/s in node B and furthermore in the node C the band is narrowed to 7/9 in accordance with the ratio of the number of paths received in UNI interface to the number of paths received in NNI in this node. Accordingly, the traffic at output of node C is 500 Mbit/s× 4/7× 7/9=222.2 Mbit/s/node, that is, 55.6 Mbit/s/user.

The band for BE traffic multiplexed in node C is narrowed to 2/9 in accordance with the ratio of the number of paths received in UNI to the number of paths received NNI in this node so that BE traffic in total is 500 Mbit/sin node C. Accordingly, the traffic at output of node C is 500 Mbit/s× 2/9=111.1 Mbit/s/node, that is, 55.6 Mbit/s/user.

As compared with the result of the band control performed as described above, the band for the traffic is limited by congestion in nodes B and C, although it is understood that the band of 55.6 Mbit/sis assigned to each node fairly in view of the allotment of band for each user.

The control part is consisted of at least 2 stages including the control part positioned at the back to realize PSC and the control part positioned at the front to secure the fairness of band allotment among users and the control part at the back can be changed in accordance with the form of service provided and any scheduler may be applied to this part. In the embodiment, the forwarding priority processing based on service classes of EF, AF and BE is realized by PQ by way of example.

### Embodiment 2

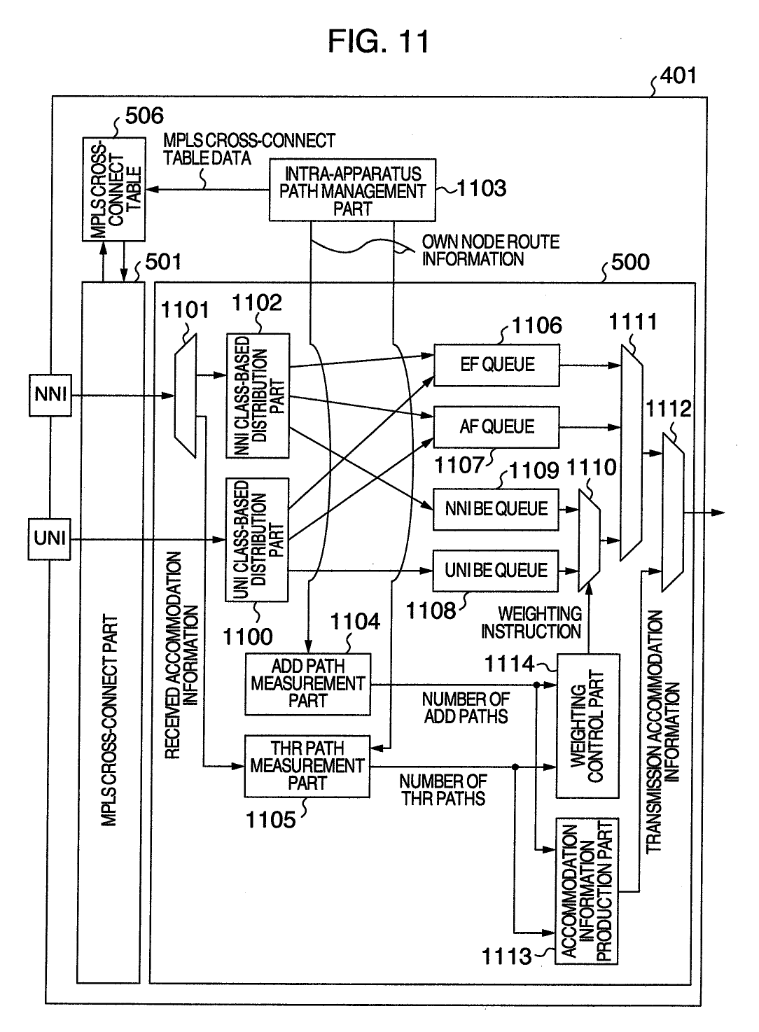

FIG. 11 schematically illustrates an example of a second block of the priority control part. In the embodiment, the method of getting the number of THR paths (flows) is different as compared with the configuration shown in the embodiment 1. In the embodiment, the number of paths (flows) from NNI is notified as accommodation information from adjacent node and the number of paths (flows) forwarded to UNI is subtracted therefrom to calculate the number of THR paths. Generally, the larger the network scale is, the larger the number of THR paths required to be managed is. In the embodiment 1, the network management apparatus manages all of THR paths in each node concentratedly, although in the embodiment 2, only difference between the number of multiplexed (ADD) paths (flows) and the number of separated (DRP) paths (flows) is managed for each node on the basis of accommodation information notified from adjacent node and the number of THR paths is calculated therefrom, so that the THR paths are managed in a dispersed manner for each node to be more advantageous in scalability.

Configuration of the embodiment is now described.

FIG. 11 schematically illustrates the band control apparatus of the embodiment centering on a priority control part 500. The band control apparatus includes an NNI class-based distribution part 1102 for distributing MPLS frames received in NNI to queues for each of service classes, a UNI class-based distribution part 1100 for distributing data received in UNI to queues for each of service classes, an accommodation information separation part 1101 for separating accommodation information in adjacent node from user signal on the basis of signal received in NNI, an intra-apparatus path management part 1103 for managing cross-connect information (path information) indicating which the path (flow) passing through apparatus is inputted from and which it is outputted to, an ADD path measurement part 1104 for measuring the number of paths (flows) forwarded from UNI to NNI of the node on the basis of the path information, a THR path measurement part 1105 for measuring the number of paths (flows) forwarded from NNI to another NNI of the node on the basis of the accommodation information received from the accommodation information separation part and the route information received from the intra-apparatus management part, an accommodation information generation part 1113 for calculating the number of paths (flows) outputted from the NNI on the basis of information gotten by the ADD path measurement part and the THR path measurement part and producing accommodation information notified to a downstream adjacent node as accommodation information of the node, an accommodation information multiplexing part 1112 for multiplexing the accommodation information generated by the accommodation information generation part with signal transmitted from NNI, a control part 1110 for performing scheduling of data forwarding in accordance with a certain algorithm and controlling the priority order of packets to be forwarded in accordance with the situation caused by an amount of traffic data, a control part 1111 at the second stage, and EF queue 1106, AF queue 1107 and BE queues which are buffer memories provided for service classes to queue data read in the control parts. Furthermore, the BE queue includes 2 queues of NNI BE queue 1109 for storing therein MPLS frame received by NNI connected to another band control apparatus and UNI BE queue 1108 for storing therein MPLS frame received by UNI connected to the user device to accommodate the user signal outputted from the user device. Interface receiving BE traffic distributes the frames to different queues in accordance with NNI and UNI. The configuration of the scheduler and the queues are the same as that of the first embodiment.

In the priority control part of the band control apparatus in the second embodiment, first, the accommodation information separation part separates the user signal and the accommodation information containing the number of paths (flows) accommodated in the adjacent node from the signal received in NNI, so that the user signal is transmitted to the NNI class-based distribution part and the received accommodation information is transmitted to the THR path measurement part. On the other hand, the signal received in UNI is transmitted to the UNI class-based distribution part.

The intra-apparatus path management part manages cross-connect information of flows in the apparatus and grasps that the flows are forwarded from which interface board to which interface board in the node. The intra-apparatus path management part transmits its own node route information to the ADD path measurement part and the THR path measurement part. The cross-connect information is based on the route information set by the network management apparatus in the embodiment 1, although in the embodiment 2 the cross-connect information does not have a form of concentratedly managing the routes by the network management apparatus but is based on the route information decided autonomously by nodes using the signaling protocol represented by RSVP, CR-LDP or the like in the autonomously dispersed type network.

The ADD path measurement part calculates the number of paths (flows) forwarded from UNI to NNI on the basis of its own node route information received from the intra-apparatus path management part and transmits it to the weighting control part as the number of ADD paths.

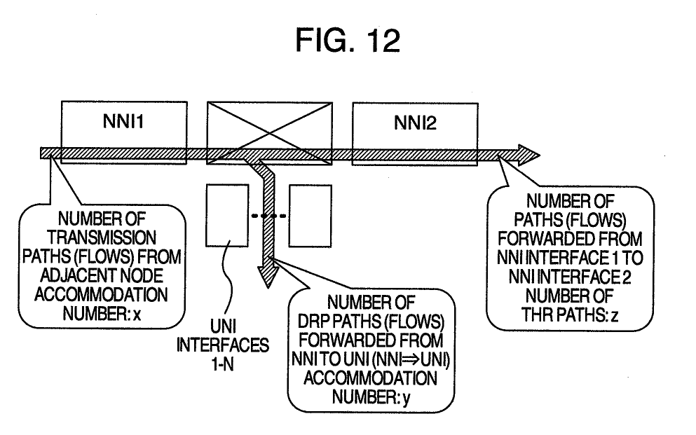

The THR path measurement part receives the accommodation information from the accommodation information separation part and recognizes the number of paths (flows) transmitted by adjacent node on the basis of the accommodation information. Furthermore, the THR path measurement part calculates the number of paths (flows) forwarded from NNI of the node to another NNI on the basis of the recognized information and the route information received from the intra-apparatus path management part and transmits it to the weighting control part and the accommodation information generation part as the number of THR paths. FIG. 12 shows a flow of calculating the number of THR paths in the THR path measurement part. The number of flows received by NNI is “X”. The packets received by NNI is forwarded to another NNI or UNI and the number of paths (flows) forwarded to another interface of them is the number of THR paths. The path forwarded to UNI is named DRP path and when the number of paths (flows) is y, the number of THR paths “z” is calculated by “z=x−y”. Since the packets received by NNI is merely forwarded to another NNI or UNI, the number of paths (flows) forwarded to NNI is calculated by subtracting the number of paths (flows) forwarded to UNI from the number of paths (flows) received by NNI.

The weighting control part 1114 transmits the ratio of the number of ADD paths received from the ADD path measurement part to the number of THR paths received from the THR path measurement part as weighting instruction.

The accommodation information generation part adds the number of ADD paths received from the ADD path measurement part and the number of THR paths received from the THR path measurement part and transmits the sum thereof as transmission accommodation information representative of the number of paths (flows) transmitted from NNI interface of the node to the accommodation information multiplexing part 1112.

The NNI class-based distribution part refers to the EXP values corresponding to the service classes given by the MPLS generation part in advance when main signal is received from the accommodation information separation part to transmit MPLS frame of EXP=7 to the EF queue, MPLS frame of EXP=5 to the AF queue and MPLS frame of EXP=1 to the NNI BE queue and write them in respective queues.

The UNI class-based distribution part refers to the EXP values corresponding to the service classes given by the MPLS genaration part in advance to transmit MPLS frame of EXP=7 to the EF queue, MPLS frame of EXP=5 to the AF queue and MPLS frame of EXP=1 to the UNI BE queue and write them in respective queues. The NNI class-based distribution part and the UNI class-based distribution part are the same in that frames are distributed to queues on the basis of the EXP values but different in that data received by NNI and data received by UNI with respect to BE traffic (EXP=1) are distributed to different queues.

The control part is to read out data from queues in accordance with specific algorithm and is of 2-stage configuration in the same manner as the first embodiment. The control part at first stage includes the scheduler such as WFQ which can control the ratio (weighting) of reading out of UNI BE queue and NNI BE queue externally. The control part at second stage includes the scheduler which can distinguish the service classes among EF, AF and BE as PSC (PHB Scheduling Class) clearly. In the embodiment, PQ (Priority Queuing) is provided in the same manner as the first embodiment by way of example.

In scheduling by the control part (WFQ) at first stage, the control part (WFQ) reads out data written in NNI BE queue and UNI BE queue in accordance with the weighting instruction from the weighting control part to be forwarded. In this configuration, BE traffic is forwarded in accordance with the numbers of respective paths (flows) and the reading ratio is varied in accordance with the ratio of the numbers of paths (flows) flowing in from UNI interface and NNI interface, so that the fairness among users is secured.

It should be further understood by those skilled in the art that although the foregoing description has been made on embodiments of the invention, the invention is not limited thereto and various changes and modifications may be made without departing from the spirit of the invention and the scope of the appended claims.

1. A communication system including a plurality of control apparatuses connected to one another through a communication network and a management apparatus to manage the control apparatuses, wherein
the management apparatus comprises:
a first path management part to generate route information of communication in the communication network; and
a first interface to transmit the route information to the control apparatuses; and
the control apparatus comprises:
a second path management part to generate path information on the basis of the route information received from the management apparatus through a public communication network;
a second interface to receive first data from another control apparatus;
a third interface to transmit and receive second data from a terminal communicating with the control apparatus;
a first memory to store therein the first data;
a second memory to store therein the second data; and
a control part to define transmission condition from the first and second memory of the first and second data on the basis of the path information read out from the second path management part.

2. A communication system according to claim 1, wherein
the first interface comprises a network node interface and the second interface comprises a user interface.

3. A communication system according to claim 1, wherein
the second path management part judges on the basis of route information whether the communication is made through first path going from the user interface to the network node interface or second path going from the network node interface to the network node interface of another control part and generates the path information.

4. A communication system according to claim 3, wherein
the control part gives weights to the first and second paths on the basis of the number of paths.

5. A communication system according to claim 1, further comprising:
a first distribution part to distribute the first data for each service class; and
a second distribution part to distribute the second data for each service class;
the first memory storing therein data distributed to best effort class by the first distribution part;
the second memory storing therein data distributed to best effort class by the second distribution part.

6. A communication system according to claim 5, further comprising:
a third memory to store therein the first and second data distributed to perfect priority class by the first and second distribution parts; and
a fourth memory to store therein the first and second data distributed to relative priority class by the first and second distribution parts;
the control part including a first control part to define transmission condition from the first and second memories and a second control part to define transmission condition from the third and fourth memories.

7. A communication system according to claim 6, wherein
the second path management part judges on the basis of route information whether the communication is made through first path going from the user interface to the network node interface or second path going from the network node interface to network node interface of another control apparatus and generates the path information and
the first control part gives weights to the first and second paths on the basis of the number of paths.

8. A communication system according to claim 1, wherein
the first path management part generates the route information corresponding to each of the plurality of control apparatuses.

9. A communication system including a plurality of control apparatuses and a communication network, wherein
the control apparatus comprises:
a first path management part to manage route information of communication;
a first interface to receive first data from a different first control apparatus;
a separation part to separate communication accommodation information and other data of the different first control apparatus from the first data;
a measurement part to generates path information received from the different first control apparatus and forwarded to a different second control apparatus on the basis of the communication accommodation information and the route information managed by the first path management part;
a second interface to receive third data from a terminal communicating with the control apparatus;
a first memory to store therein the first data;
a second memory to store therein the second data; and
a control part to define transmission condition from the first and second memories of the first and second data using the path information read out from the measurement part.

10. A communication system according to claim 9, wherein
the measurement part calculates the number of paths received from the different first control apparatus and forwarded to the different second control apparatus to set it as the path information.

11. A communication system according to claim 9, wherein
the first interface comprises a network node interface and the second interface comprises a user interface.

12. A communication system according to claim 9, wherein
the first interface comprises a network node interface and the second interface comprises a user interface, the measurement part subtracting data going to the user interface from the first data to calculate the number of paths.

13. A communication system according to claim 9, further comprising:
a first distribution part to distribute said the other data for each service class; and
a second distribution part to distribute the second data for each service class;
the first memory storing therein data distributed to best effort class by the first distribution part;
the second memory storing therein data distributed to best effort class by the second distribution part.

14. A communication system according to claim 12, wherein
the number of paths is the number of paths forwarded from the network node interface to the network node interface of the different second control apparatus.

15. A communication system according to claim 12, further comprising a communication accommodation information generation part,
and wherein
the first path management part judges on the basis of the route information whether the communication is made through first path going from the user interface to the network node interface or second path going from the network node interface to the network node interface of a different control apparatus and
the communication accommodation information generation part generates transmission accommodation information transmitted to the other second control apparatus on the basis of the number of paths and the number of first paths.
